(19) United States
(12) Patent Application Publication
(10) Pub. No.: US 2022/0284262 A1
(43) Pub. Date: Sep. 8, 2022

(54) NEURAL NETWORK OPERATION APPARATUS AND QUANTIZATION METHOD

(71) Applicants: SAMSUNG ELECTRONICS CO., LTD., Suwon-si (KR); UNIST(ULSAN NATIONAL INSTITUTE OF SCIENCE AND TECHNOLOGY), Ulsan (KR)

(72) Inventors: Sehwan LEE, Seongnam-si (KR); Hyeonuk SIM, Iksan-si (KR); Jongeun LEE, Ulsan (KR)

(73) Assignees: SAMSUNG ELECTRONICS CO., LTD., Suwon-si (KR); UNIST(ULSAN NATIONAL INSTITUTE OF SCIENCE AND TECHNOLOGY), Ulsan (KR)

(21) Appl. No.: 17/368,470

(22) Filed: Jul. 6, 2021

(30) Foreign Application Priority Data
Mar. 4, 2021 (KR) 10-2021-0028636
Mar. 10, 2021 (KR) 10-2021-0031354

(51) Int. Cl. G06N 3/04

(52) U.S. Cl. CPC G06N 3/04

(57) ABSTRACT

A neural network operation apparatus and method implementing quantization is disclosed. The neural network operation method may include receiving a weight of a neural network, a candidate set of quantization points, and a bitwidth for representing the weight, extracting a subset of quantization points from the candidate set of quantization points based on the bitwidth, calculating a quantization loss based on the weight of the neural network and the subset of quantization points, and generating a target subset of quantization points based on the quantization loss.

### CROSS-REFERENCE TO RELATED APPLICATIONS

This application claims the benefit under 35 USC § 119(a) of Korean Patent Application No. 10-2021-0028636, filed on Mar. 4, 2021, and Korean Patent Application No. 10-2021-0031354, filed on Mar. 10, 2021, in the Korean Intellectual Property Office, the entire disclosures of which are incorporated herein by reference for all purposes.

### BACKGROUND

### 1. Field

The following description relates to a neural network operation apparatus and quantization method.

### 2. Description of Related Art

In deep learning, quantization techniques may improve power efficiency while reducing computation amounts or complexities. Quantization is an effective optimization method that may greatly reduce the computational complexity of a deep neural network (DNN).

DNN quantization may reduce the size of a neural network model (for example, the bitwidth of weights) (DNN compression), and may improve the efficiency of a deep learning processor unit (DPU).

DNN compression may only need to perform weight quantization but not activation value quantization and thus, may be difficult to apply directly to a DPU.

DNN quantization may also be applied directly to a DPU, and principally focuses on reducing the precision of multipliers requiring a high cost.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a processor-implemented neural network operation method includes receiving a weight of a neural network, a candidate set of quantization points, and a bitwidth that represents the received weight; extracting a subset of quantization points from the candidate set of quantization points based on the bitwidth; calculating a quantization loss based on the received weight and the subset of quantization points; and generating a target subset of quantization points based on the calculated quantization loss.

The method may include generating the candidate set of quantization points based on log-scale quantization.

The generating of the candidate set of quantization points may include obtaining a first quantization point based on the log-scale quantization; obtaining a second quantization point based on the log-scale quantization; and generating the candidate set of quantization points based on a sum of the first quantization point and the second quantization point.

The extracting of the subset of quantization points may include determining a number of elements of the subset based on the bitwidth; and extracting a subset corresponding to the number of elements from the candidate set of quantization points.

The calculating of the quantization loss may include calculating the quantization loss based on the received weight of the neural network and a weight quantized by the quantization points included in the extracted subset of quantization points.

The calculating of the quantization loss based on the received weight of the neural network and the weight quantized by the quantization points included in the extracted subset of quantization points may include calculating an L2 loss or an L4 loss for a difference between the received weight of the neural network and the quantized weight as the quantization loss.

The generating of the target subset of quantization points may include determining a subset of quantization points that minimizes the quantization loss to be the target subset.

In a general aspect, a neural network apparatus includes a memory, configured to store a weight of a neural network and a target subset of quantization points extracted from a candidate set of quantization points to quantize the weight of the neural network; a decoder, configured to select a target quantization point from the target subset of quantization points based on the weight of the neural network; a shifter, configured to perform a multiplication operation based on the target quantization point; and an accumulator, configured to accumulate an output of the shifter.

The target subset may be generated based on the weight of the neural network, and a quantization loss for a subset of quantization points extracted from the candidate set.

The shifter may include a first shifter, configured to perform a first multiplication operation for input data based on a first quantization point included in the target quantization point; and a second shifter, configured to perform a second multiplication operation for the input data based on a second quantization point included in the target quantization point.

The decoder may include a multiplexer, configured to multiplex the target quantization point using the weight as a selector.

The target quantization point may be shared between multiply-accumulate (MAC) operators.

In a general aspect, a neural network apparatus includes a receiver, configured to receive a weight of a neural network, a candidate set of quantization points, and a bitwidth that represents the weight; and one or more processors, configured to extract a subset of quantization points from the candidate set of quantization points based on the bitwidth, calculate a quantization loss based on the weight of the neural network and the subset of quantization points, and generate a target subset of quantization points based on the calculated quantization loss.

The one or more processors may be further configured to generate the candidate set based on log-scale quantization.

The one or more processors may be further configured to obtain a first quantization point based on the log-scale quantization, obtain a second quantization point based on the log-scale quantization, and generate the candidate set of quantization points based on a sum of the first quantization point and the second quantization point.

The one or more processors may be further configured to determine a number of elements of the subset based on the bitwidth, and extract a subset corresponding to the number of elements from the candidate set of quantization points.

The one or more processors may be further configured to calculate the quantization loss based on the weight of the neural network and a weight quantized by the quantization points included in the subset.

The one or more processors may be further configured to calculate an L2 loss or an L4 loss for a difference between the weight of the neural network and the quantized weight as the quantization loss.

The one or more processors may be further configured to determine a subset that minimizes the quantization loss to be the target subset.

Other features and aspects will be apparent from the following detailed description, the drawings, and the claims.

### BRIEF DESCRIPTION OF DRAWINGS

FIG. 1 illustrates an example neural network operation apparatus, in accordance with one or more embodiments.

FIG. 2A illustrates an example of generating a target subset of quantization points by an example neural network operation apparatus.

FIG. 2B illustrates an example of pseudocode implementing the process of FIG. 2A, in accordance with one or more embodiments.

FIG. 3 illustrates an example quantization point set (QPS), in accordance with one or more embodiments.

FIG. 4 illustrates an example of performing a neural network operation using a target subset, in accordance with one or more embodiments.

FIG. 5 illustrates an example of an operation of a decoder shown in FIG. 4, in accordance with one or more embodiments.

FIG. 6 illustrates an example of an accelerator implementing the neural network operation apparatus of FIG. 1, in accordance with one or more embodiments.

FIG. 7 illustrates an example smart phone implementing the neural network operation apparatus of FIG. 1, in accordance with one or more embodiments.

FIG. 8 illustrates an example of a flow of the operation of the neural network operation apparatus of FIG. 1.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains after an understanding of the disclosure of this application. Terms, such as those defined in commonly used dictionaries, are to be interpreted as having a meaning that is consistent with their meaning in the context of the relevant art and the disclosure of the present application, and are not to be interpreted in an idealized or overly formal sense unless expressly so defined herein.

Hereinafter, example embodiments will be described in detail with reference to the accompanying drawings. When describing the example embodiments with reference to the accompanying drawings, like reference numerals refer to like components and a repeated description related thereto will be omitted.

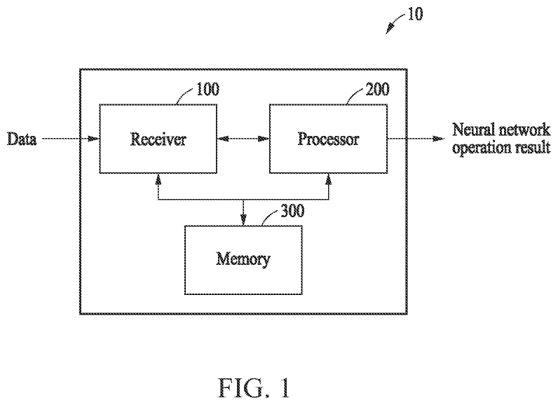

FIG. 1 illustrates an example neural network operation apparatus, in accordance with one or more embodiments.

Referring to FIG. 1, a neural network operation apparatus 10 may receive data, perform a neural network operation, and generate a neural network operation result.

Technological automation of pattern recognition or analyses, for example, has been implemented through processor implemented neural network models, as specialized computational architectures, that after substantial training may provide computationally intuitive mappings between input patterns and output patterns or pattern recognitions of input patterns. The trained capability of generating such mappings or performing such pattern recognitions may be referred to as a learning capability of the neural network. Such trained capabilities may also enable the specialized computational architecture to classify such an input pattern, or portion of the input pattern, as a member that belongs to one or more predetermined groups. Further, because of the specialized training, such specially trained neural network may thereby have a generalization capability of generating a relatively accurate or reliable output with respect to an input pattern that the neural network may not have been trained for, for example.

The neural network may be a general model that has the ability to solve a problem, where nodes (or neurons) forming the network through synaptic combinations change a connection strength of synapses through training. However, such reference to “neurons” is not intended to impart any relatedness with respect to how the neural network architecture computationally maps or thereby intuitively recognizes information, and how a human's neurons operate. In other words, the term “neuron” is merely a term of art referring to the hardware implemented nodes of a neural network, and will have a same meaning as a node of the neural network.

The neurons of the neural network may include a combination of weights or biases. The neural network may include one or more layers each including one or more nodes (or neurons). The neural network may infer a desired result from a predetermined input by changing the weights of the neurons through learning.

The neural network may include, as non-limiting examples, a deep neural network (DNN). The neural network may be one or more of a fully connected network, a convolutional neural network (CNN), a recurrent neural network (RNN), a perceptron, a multiplayer perceptron, a feed forward (FF), a radial basis network (RBF), a deep feed forward (DFF), a long short-term memory (LSTM), a gated recurrent unit (GRU), an auto encoder (AE), a variational auto encoder (VAE), a denoising auto encoder (DAE), a sparse auto encoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural turning machine (NTM), a capsule network (CN), a Kohonen network (KN), and an attention network (AN), or may include different or overlapping neural network portions respectively with such full, convolutional, or recurrent connections.

The neural network operation apparatus 10 may be configured to perform, as non-limiting examples, object classification, object recognition, voice recognition, and image recognition by mutually mapping input data and output data in a nonlinear relationship based on deep learning. Such deep learning is indicative of processor implemented machine learning schemes for solving issues, such as issues related to automated image or speech recognition from a data set, as non-limiting examples. Herein, it is noted that use of the term ‘may’ with respect to an example or embodiment, e.g., as to what an example or embodiment may include or implement, means that at least one example or embodiment exists where such a feature is included or implemented while all examples and embodiments are not limited thereto.

The neural network operation apparatus 10 may perform a neural network operation. The neural network operation apparatus 10 may perform quantization for the neural network operation. For example, the neural network operation apparatus 10 may quantize weights (or model parameters) of the neural network.

The neural network operation apparatus 10 may perform a neural network operation based on the quantized neural network.

The neural network operation apparatus 10 may quantize the neural network by generating a target subset of quantization points using a subset extracted from a candidate set of quantization points.

The neural network operation apparatus 10 may be implemented by a printed circuit board (PCB) such as a motherboard, an integrated circuit (IC), or a system on a chip (SoC). In an example, the neural network operation apparatus 10 may be implemented by an application processor.

Additionally, the neural network operation apparatus 10 may be implemented, as non-limiting examples, in a personal computer (PC), a data server, or a portable device.

The portable device may be implemented, as non-limiting examples, as a laptop computer, a mobile phone, a smart phone, a tablet PC, a mobile internet device (MID), a personal digital assistant (PDA), an enterprise digital assistant (EDA), a digital still camera, a digital video camera, a portable multimedia player (PMP), a personal navigation device or portable navigation device (PND), a handheld game console, an e-book, or a smart device. The smart device may be implemented as a smart watch, a smart band, or a smart ring.

The neural network operation apparatus 10 includes a receiver 100, a processor 200, and a memory 300. The neural network operation apparatus 10 may further include a separate operator. The neural network operation apparatus 10 may include a decoder, a shifter, and an accumulator. In an example, the neural network operation apparatus 10 may further store instructions, e.g., in memory 300, which when executed by the processor 200 configure the processor 200 to implement one or more, or any combination of, operations herein. The processor 200 and the memory 300 may be respectively representative of one or more processors 200 and one or more memories 300.

The receiver 100 may include a reception interface. The receiver 100 may receive a weight of the neural network, the candidate set of quantization points, and a bitwidth for representing the weight. The receiver 100 may output, to the processor 200, the weight of the neural network, the candidate set of quantization points, and the bitwidth for representing the weight.

The processor 200 may process data stored in the memory 300. The processor 200 may execute a computer-readable code (for example, software) stored in the memory 300 and instructions triggered by the processor 200.

The “processor 200” may be a data processing device implemented by hardware including a circuit having a physical structure to perform desired operations. In an example, the desired operations may include code or instructions included in a program.

In an example, the hardware-implemented data processing device may include a microprocessor, a central processing unit (CPU), a processor core, a multi-core processor, a multiprocessor, an application-specific integrated circuit (ASIC), and a field-programmable gate array (FPGA).

The processor 200 may generate a target subset of quantization points and perform the neural network operation based on the generated target subset.

The processor 200 may receive, from the receiver 100, the weight of the neural network, the candidate set of quantization points, and the bitwidth for representing the weight.

The quantization points may be a finite set of predefined values for approximating an input value (for example, a weight). The number of quantization points may be limited by precision or bitwidth. The bitwidth may indicate the length of binary digits required to represent data (for example, weight).

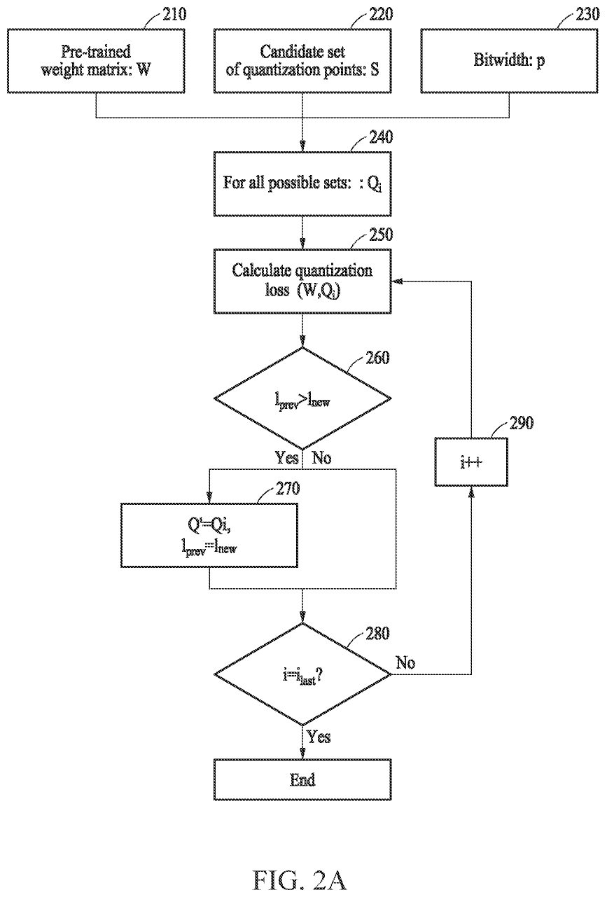

The processor 200 may generate the candidate set based on log-scale quantization. The processor 200 may obtain a first quantization point based on log-scale quantization. The processor 200 may obtain a second quantization point based on log-scale quantization. The processor 200 may generate the candidate set based on the sum of the first quantization point and the second quantization point. The process of generating the candidate set will be described in detail with reference to FIG. 2A.

The processor 200 may extract the subset of quantization points from the candidate set based on the bitwidth. The processor 200 may determine the number of elements of the subset based on the bitwidth. The processor 200 may extract a subset corresponding to the determined number of elements from the candidate set.

The processor 200 may calculate a quantization loss based on the weight and the extracted subset. The processor 200 may calculate the quantization loss based on the weight and a weight quantized by the quantization points included in the subset. The processor 200 may calculate an L2 loss or an L4 loss for a difference between the weight and the quantized weight as the quantization loss.

The processor 200 may generate the target subset of quantization points based on the quantization loss. The processor 200 may determine a subset that minimizes the quantization loss to be the target subset.

The neural network operation apparatus 10 may perform a neural network operation using the decoder, the shifter, and the accumulator.

The decoder may select a target quantization point from the target subset based on the weight. The decoder may include a multiplexer configured to multiplex the target quantization point using the weight as a selector.

The shifter may perform a multiplication based on the target quantization point. The shifter may include a first shifter configured to perform a multiplication for input data based on a first quantization point included in the target quantization point, and a second shifter configured to perform a multiplication for the input data based on a second quantization point included in the target quantization point.

The target quantization point may be shared between multiply-accumulate (MAC) operators.

The accumulator may accumulate an output of the shifter. The accumulator may store the accumulated output in the memory 300.

The memory 300 may store the data for the neural network operation. The memory 300 may store the weight of the neural network and the target subset of quantization points extracted from the candidate set of quantization points for quantizing the weight.

The memory 300 stores instructions (or programs) executable by the processor 200. In an example, the instructions may include instructions to perform an operation of the processor and/or an operation of each element of the processor.

The memory 300 may be implemented as a volatile memory device or a non-volatile memory device.

The volatile memory device may be implemented as a dynamic random access memory (DRAM), a static random access memory (SRAM), a thyristor RAM (T-RAM), a zero capacitor RAM (Z-RAM), or a twin transistor RAM (TTRAM).

The non-volatile memory device may be implemented as an electrically erasable programmable read-only memory (EEPROM), a flash memory, a magnetic RAM (M RAM), a spin-transfer torque (STT)-MRAM, a conductive bridging RAM(CBRAM), a ferroelectric RAM (FeRAM), a phase change RAM (PRAM), a resistive RAM (RRAM), a nanotube RRAM, a polymer RAM (PoRAM), a nano floating gate Memory (NFGM), a holographic memory, a molecular electronic memory device), or an insulator resistance change memory.

The operator may perform a neural network operation. The operator may include an accelerator. The accelerator may be a computer system or special hardware designed to accelerate a neural network application. In an example, the decoder, the shifter, and the accumulator may be implemented in the operator.

The operator may include an accelerator. The accelerator may include a graphics processing unit (GPU), a neural processing unit (NPU), a field-programmable gate array (FPGA), an application-specific integrated circuit (ASIC), or an application processor (AP). Alternatively, the accelerator may be implemented as a software computing environment, such as a virtual machine. In an example, the operator may include at least one multiply-accumulate (MAC) operator. In some examples, the operator may not be included in the neural network operation apparatus but may be positioned outside.

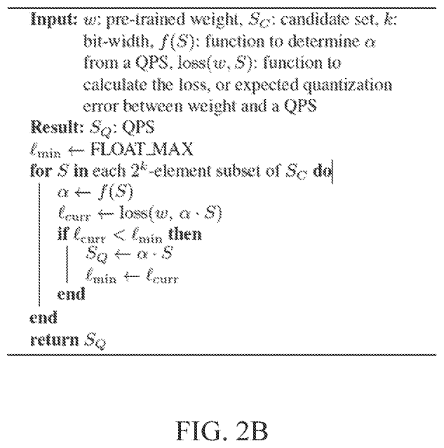

FIG. 2A illustrates an example of generating a target subset of quantization points by a neural network operation apparatus, FIG. 2B illustrates an example of pseudocode implementing the process of FIG. 2A, and FIG. 3 illustrates an example of a quantization point set (QPS).

Referring to FIGS. 2A and 2B, the receiver 100 may include a receiving interface. The receiver 100 may receive a weight 210 of a neural network, a candidate set 220 of quantization points, and a bitwidth 230 for representing the weight. The weight 210 of the neural network may include a pre-trained weight matrix.

The processor 200 may generate a candidate set of quantization points using a quantizer.

A simulated quantizer Q may be a function whose domain and codomain are real numbers and that simulates an effect of quantization by consecutively performing quantization and dequantization. The operation of the simulated quantizer Q may be expressed by Equation 1 below.

Q: [symbol] → [symbol] =dequantizier○quantizer Equation 1:

The processor 200 may define a quantization point set (QPS) to fall within the range of the simulated quantization function. All quantization schemes may be interpreted as an operation of mapping an input to the nearest element in a QPS. Many quantization schemes may differ in terms of the scheme of defining a QPS. FIG. 3 shows an example of a QPS.

The processor 200 may define a unified quantizer as expressed by Equation 2 below.

$$Q ( x , {S}_{Q} ) = {arg min}_{p ∈ {S}_{Q}} \vert x - p \vert . \qquad Equation 2$$

A QPS for linear quantization and a QPS for log-scale quantization may be defined below by Equation 3 and Equation 4, respectively.

S_{Q}^{lin}(i)={s·i|i=−N, . . . ,N−1} Equation 3:

S_{Q}^{log}(s)={−s·s⁻ⁱ|i=0, . . . ,N−1}∪{0}Å{s·2⁻ⁱ|i=0, . . . ,N−2}} Equation 4:

Here, s denotes a scaling parameter, and 2N denotes the number of quantization points.

In addition, for ₖ-bit quantization, N=2^{K-1}. In this case, the input may be symmetrical around “0”.

The processor 200 may generate the candidate set 220 based on log-scale quantization. The processor 200 may obtain a first quantization point based on log-scale quantization. The processor 200 may obtain a second quantization point based on log-scale quantization. The processor 200 may generate the candidate set based on the sum of the first quantization point and the second quantization point.

That is, the processor 200 may perform quantization using two words (for example, a first quantization point and a second quantization point) to improve the accuracy of log-scale quantization. The processor 200 may perform 2-word quantization using a QPS as expressed by Equation 5 below.

S_{Q}^{2 log}={q₁+q₂|q₁∈S_{Q}^{log},q₂∈S_{Q}^{log}} Equation 5:

The processor 200 may perform subset quantization. The processor 200 may define S_{Q} not as a fixed set but as an arbitrary subset of a larger set whose cardinality is 2N. Here, the larger set may be referred to as a candidate set S_{C}, and a QPS based on the candidate set may be expressed by Equation 6 below.

S_{Q}^{sq}(s)={pᵢ∈S_{C}(s)|e=1, . . . ,2N} Equation 6:

Here, bit-precision in subset quantization may restrict only the cardinality of a QPS but not the cardinality of a candidate set. Equation 6 does not uniquely define a QPS of a quantizer used by the processor 200, and any subset of S_{C} may be a QPS. Thus, the processor 200 may adjust the QPS suitably for each layer or channel.

The processor 200 may extract the subset of quantization points from the candidate set based on the bitwidth. The processor 200 may determine the number of elements of the subset based on the bitwidth. The processor 200 may extract a subset corresponding to the determined number of elements from the candidate set.

The processor 200 may perform quantization using analytic quantization. For a candidate set, the processor 200 may use two-word log-scale quantization, thereby reducing a hardware cost and increasing the power of representation. S_{C}=S_{Q}^{2 log} may be satisfied in the two-word log-scale quantization method.

The processor 200 may perform two steps to determine a quantization parameter. The processor 200 may generate a QPS by selecting a candidate set, even after determining the candidate set by a fixed parameter (for example, α).

In other words, the processor 200 may determine the parameter and then select a subset based on the parameter. A scaling parameter may be used to adjust the range in which the selected quantization points change.

In analytic quantization, a QPS according to linear quantization and a QPS according to log-scale quantization may be expressed as follows.

$$Linear {\to }^{s} {S}_{Q}^{lin} ( s ) \\ Log - scale {\to }^{s} {S}_{Q}^{lo g} ( s )$$

In subset quantization, the processor 200 may obtain the scaling parameter α using the following orders.

$${S}_{C} {\to }^{α} {S}_{C} ( α ) {\to }^{choose} {S}_{Q}^{sq} ( α ) \\ {S}_{C} {\to }^{choose} {S}_{Q}^{sq} {\to }^{α} {S}_{Q}^{sq} ( α )$$

Here, the choose operation may not be differentiable. The processor 200 may use the choose operation as a search operation and thereby determine the scaling parameter using analytic quantization.

If S_{C} does not have any parameter, the processor 200 may scale the largest quantization point to “1” (or another arbitrary value) by multiplying the scaling parameter α to an arbitrary subset S or S_{C}.

In order to generalize the scaling operation described above, the processor 200 may define a function f to determine an optimal scaling parameter α for a given set of quantization points S having a scaled version α·S.

The processor 200 may obtain an optimal QPS from the algorithm of FIG. 2B, by using a loss function for calculating a quantization loss or using an expected quantization error between the weight and a QPS. The optimal QPS may be a QPS that minimizes the quantization error.

QPS search may be intended to minimize a quantization loss for each layer. The processor 200 may calculate the quantization loss using an L2 (for example, L2-norm) or L4 (for example, L4-norm) error of a quantization weight.

The algorithm approach of FIG. 2B does not involve a training or inference process and thus, may have a complexity of

$$( \begin{matrix}\vert {S}_{C} \vert \\ \vert {S}_{Q} \vert\end{matrix} )$$

and operate very fast.

If the bitwidth is k, the processor 200 may extract a subset including 2^{k} elements from a candidate set. In other words, the processor 200 may generate a subset of quantization points by extracting 2^{k} values from all the values that may be expressed by the sum of two logarithmic words. In the example of FIG. 2A, all possible sets in operation 240 may be the number of all cases of the extracted subset.

In operation 250, the processor 200 may calculate a quantization loss based on the weight and the extracted subset. The processor 200 may calculate the quantization loss based on the weight and a weight quantized by the quantization points included in the subset. The processor 200 may calculate an L2 loss or an L4 loss for a difference between the weight and the quantized weight as the quantization loss.

The processor 200 may calculate quantization losses for all extracted subsets. For example, when an L4 error is used, the processor 200 may calculate the quantization loss using the sum of fourth powers of differences of true values of weights and nearest quantized weights.

The processor 200 may calculate quantization losses for all subsets and then determine a subset with the smallest quantization loss to be the target subset. The loss function for calculating the quantization loss may be defined differently depending on the neural network.

In the example of FIG. 2B, the processor 200 may compare the calculated quantization loss I_{curr} (or I_{new}) with Iₘᵢₙ (or Iₚᵣₑᵥ), in operation 260. If I_{curr} is less than Iₘᵢₙ, the processor 200 may substitute I_{curr} for Iₘᵢₙ, in operation 270.

In operation 280, the processor 200 may determine whether the index i is the last one. If i is the last index, the processor 200 may terminate the algorithm. If i is not the last index, the processor 200 may add “1” to i, in operation 290. The processor 200 may iteratively perform the process of operations 250 to 290.

The processor 200 may search for a subset that minimizes the quantization loss by performing the algorithm as shown in FIGS. 2A and 2B.

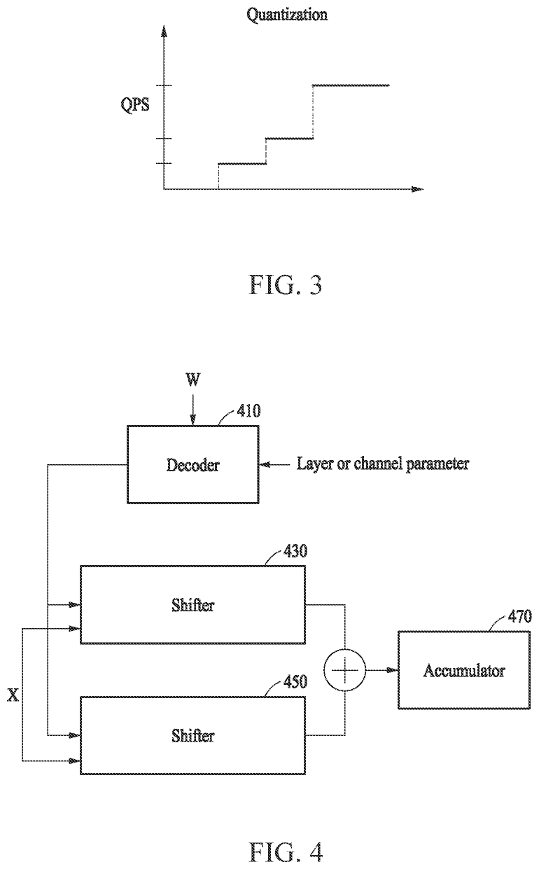

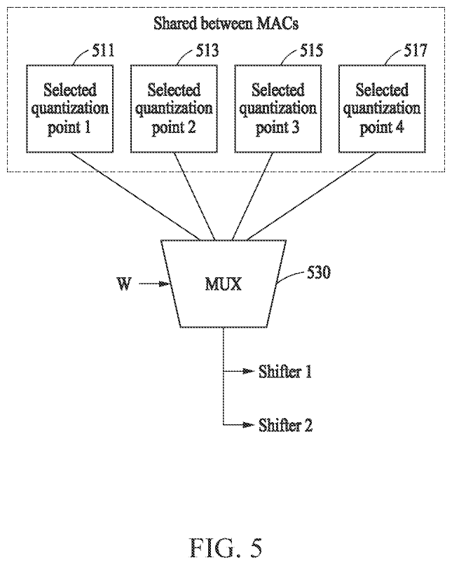

FIG. 4 illustrates an example of performing a neural network operation using a target subset, in accordance with one or more embodiments, and FIG. 5 illustrates an example of an operation of a decoder shown in FIG. 4.

Referring to FIGS. 4 and 5, a neural network operation apparatus, (for example, the neural network operation apparatus 10 of FIG. 1), may include a decoder 410, a shifter 430 or 450, and an accumulator 470.

The neural network operation apparatus 10 may perform a neural network operation using the decoder 410, the shifter 430 or 450, and the accumulator 470.

A processor (for example, the processor 200 of FIG. 1) may generate a target subset that may minimize a quantization loss in a layer of a neural network or application in the manner described above.

The processor 200 may encode weight (for example, pre-trained weight) values to the nearest quantization points. Candidates for the quantization points may include all numbers that may be expressed by a sum of two logarithmic words. The processor 200 may generate a subset of quantization points by extracting 2\hat{ }numbers (corresponding to the bitwidth) from all the numbers.

The processor 200 may define various loss functions. For example, the processor 200 may define a quantization loss using an L4 loss.

The neural network operation apparatus 10 may perform the neural network operation using the weight of the neural network stored in the memory and the target subset of quantization points extracted from the candidate set of quantization points for quantifying the weight.

The decoder 410 may select a target quantization point from the target subset based on the weight. The decoder 410 may include a multiplexer 530 configured to multiplex the target quantization point using the weight as a selector.

The shifter 430 or 450 may perform a multiplication operation based on the target quantization point. The shifter 430 or 450 may include a first shifter 430 configured to perform a multiplication operation for input data based on a first quantization point included in the target quantization point, and a second shifter 450 configured to perform a multiplication operation for the input data based on a second quantization point included in the target quantization point.

The target quantization point may be shared between MAC operators.

The accumulator 470 may accumulate an output of the shifter 430 or 450. The accumulator 470 may store the accumulated output in the memory 300.

The neural network operation apparatus 10 may perform an operation between a weight W and a fixed-point number X, as in the example of FIG. 4. X may have a linear value. The weight may be quantized based on the target quantization subset described above. An arithmetic unit may be determined by a candidate set.

For example, when a two-word log-scale quantization method is used, one adder may be coupled to the output terminals of the two shifters 430 and 450.

When two bitwidths are used as in the example of FIG. 5, the target subset of quantization points may have four types of selected quantization points 511, 513, 515, and 517. In the example of FIG. 5, each of the selected quantization points 511, 513, 515, and 517 may include two quantized weights. The number of quantization points and quantized weights included in the quantization points may differ depending on the bitwidth.

The example of FIG. 5 shows a case of 3-bit subset quantization. Since 3-bit includes a sign bit, there may be four selected quantization points 511, 513, 515, and 517.

Accordingly, the multiplexer 530 may have four inputs. Weights output from the multiplexer 530 may each be 2-bit.

The target quantization points 511, 513, 515, and 517 generated by the processor 200 in the manner described above may be shared between MAC operators. The target quantization points may be individually optimized for each layer of a neural network or application. That is, layers of the neural network or application may have target subsets of different optimized quantization points.

Each MAC may perform multiplication (or shift) and accumulation operations by decoding a weight expressed with a small bitwidth to two logarithmic words through the decoder 410. An operation in a quantized state may use a small cost compared to a fixed-point multiplier requiring relatively high precision.

The decoder 410 may operate in a manner that stores a target subset of pre-stored quantization points in a shared memory (for example, register) and multiplexes the target subset of quantization points using the weight as a selector.

Using the operation method described above, the neural network operation apparatus 10 may dramatically reduce the model size compared to uniform quantization or non-uniform quantization (up to 3-bit) and enable the operator to operate lightly compared to the fixed-point multiplier.

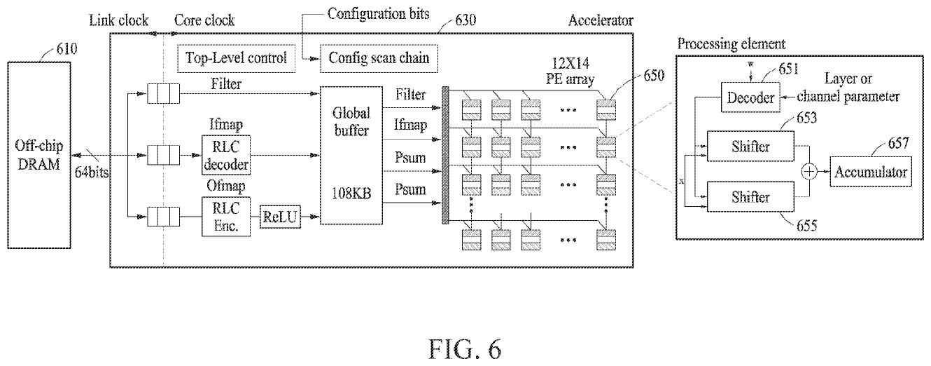

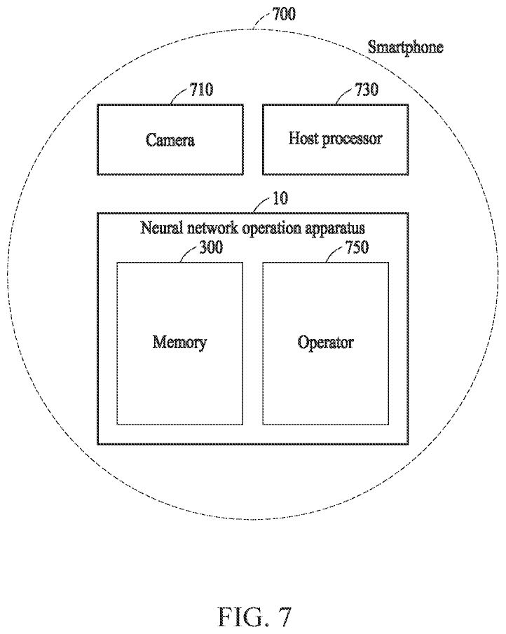

FIG. 6 illustrates an example of an accelerator implementing the neural network operation apparatus of FIG. 1, and FIG. 7 illustrates an example of a smart phone implementing the neural network operation apparatus of FIG. 1.

Referring to FIGS. 6 and 7, the example neural network operation apparatus 10 may be included in an accelerator 630 or a predetermined electronic device (for example, a smartphone 700). The neural network operation apparatus 10 may substitute for operators in various accelerator structures.

In the example of FIG. 6, the accelerator 630 may exchange data with an off-chip DRAM (610). The neural network operation apparatus 10 may substitute for processing elements (PEs) 650 in the accelerator 630, as in the example of FIG. 6. That is, a single PE 650 may include a decoder 651, a shifter 653, a shifter 655, and an accumulator 657. The operations of the decoder 651, the shifter 653, the shifter 655, and the accumulator 657 are the same as described above.

The neural network operation apparatus 10 may be less costly than the original 16-bit fixed-point multiplier, and may have a smaller size of a neural network model and a small bitwidth of one weight value at a level of 3-bit to 4-bit and thus, may reduce a buffer memory size that uses most areas and energy.

The neural network operation apparatus 10 may be embedded, as an example, in the smartphone 700. In the example of FIG. 7, the smartphone 700 may include a camera 710, a host processor 730, and the neural network operation apparatus 10. The neural network operation apparatus 10 may further include the memory 300 and an operator 750. The operator 750 may include the decoder 651, the shifter 653, the shifter 655, and the accumulator 657.

Since the smartphone 700 has energy constraints, it may be difficult to handle many high-precision operations. However, the neural network operation apparatus 10 may dramatically reduce computational cost and memory accesses and thus be usefully applied to a mobile device such as the smartphone 700.

The neural network operation apparatus 10 may operate as a matrix multiplier, and a model with a size reduced about four or more times compared to 16-bit precision may be stored in the memory 300 having a relatively small capacity.

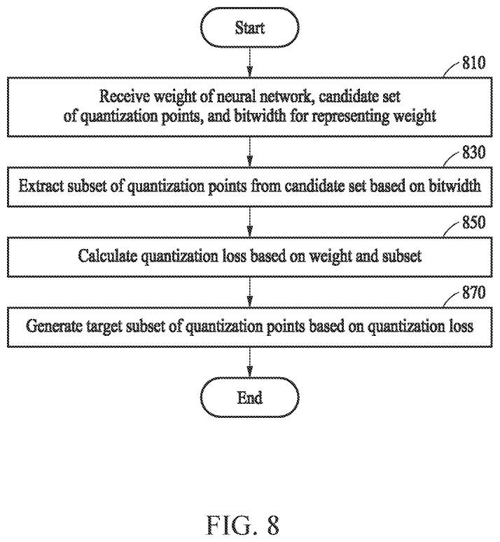

FIG. 8 illustrates an example of a flow of the operation of the neural network operation apparatus of FIG. 1, in accordance with one or more embodiments. The operations in FIG. 8 may be performed in the sequence and manner as shown, although the order of some operations may be changed or some of the operations omitted without departing from the spirit and scope of the illustrative examples described. Many of the operations shown in FIG. 8 may be performed in parallel or concurrently. One or more blocks of FIG. 8, and combinations of the blocks, can be implemented by special purpose hardware-based computer that perform the specified functions, or combinations of special purpose hardware and computer instructions. In addition to the description of FIG. 8 below, the descriptions of FIGS. 1-7 are also applicable to FIG. 8, and are incorporated herein by reference. Thus, the above description may not be repeated here.

Referring to FIG. 8, in operation 810, a receiver, (for example, the receiver 100 of FIG. 1), may receive a weight of a neural network, a candidate set of quantization points, and a bitwidth for representing the weight.

A processor (for example, the processor 200 of FIG. 1) may generate the candidate set based on log-scale quantization. The processor 200 may obtain a first quantization point based on log-scale quantization. The processor 200 may obtain a second quantization point based on log-scale quantization. The processor 200 may generate the candidate set based on the sum of the first quantization point and the second quantization point.

In operation 830, the processor 200 may extract the subset of quantization points from the candidate set based on the bitwidth. The processor 200 may determine the number of elements of the subset based on the bitwidth. The processor 200 may extract a subset corresponding to the determined number of elements from the candidate set.

In operation 850, the processor 200 may calculate a quantization loss based on the weight and the extracted subset. The processor 200 may calculate the quantization loss based on the weight and a weight quantized by the quantization points included in the subset. The processor 200 may calculate an L2 loss or an L4 loss for a difference between the weight and the quantized weight as the quantization loss.

In operation 870, the processor 200 may generate the target subset of quantization points based on the quantization loss. The processor 200 may determine a subset that minimizes the quantization loss to be the target subset.

A neural network operation apparatus of one or more embodiments may be configured to reduce the size of a neural network model while improving the neural network operation performance, thereby solving such a technological problem and providing a technological improvement by advantageously reducing costs and increasing a calculation speed of the neural network operation apparatus of one or more embodiments over the typical neural network apparatus.

The examples discussed above may reduce the size of a neural network model (for example, the bitwidth of weights) (DNN compression), and may improve the efficiency of a deep learning processor unit (DPU).

The neural network apparatuses such as the neural network operation apparatus 10, the receiver 100, processor 110, processor 200, memory 300, and other apparatuses, units, modules, devices, and other components described herein and with respect to FIGS. 1-8, are implemented by hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods that perform the operations described in this application and illustrated in FIGS. 1-8 are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller, e.g., as respective operations of processor implemented methods. One or more processors, or a processor and a controller, may perform a single operation, or two or more operations.

Instructions or software to control computing hardware, for example, one or more processors or computers, to implement the hardware components and perform the methods as described above may be written as computer programs or instructions, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computers using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A processor-implemented neural network operation method, comprising:
receiving a weight of a neural network, a candidate set of quantization points, and a bitwidth that represents the received weight;
extracting a subset of quantization points from the candidate set of quantization points based on the bitwidth;
calculating a quantization loss based on the received weight and the subset of quantization points; and
generating a target subset of quantization points based on the calculated quantization loss.

2. The method of claim 1, further comprising:
generating the candidate set of quantization points based on log-scale quantization.

3. The method of claim 2, wherein the generating of the candidate set of quantization points comprises:
obtaining a first quantization point based on the log-scale quantization;
obtaining a second quantization point based on the log-scale quantization; and
generating the candidate set of quantization points based on a sum of the first quantization point and the second quantization point.

4. The method of claim 1, wherein the extracting of the subset of quantization points comprises:
determining a number of elements of the subset based on the bitwidth; and
extracting a subset corresponding to the number of elements from the candidate set of quantization points.

5. The method of claim 1, wherein the calculating of the quantization loss comprises calculating the quantization loss based on the received weight of the neural network and a weight quantized by the quantization points included in the extracted subset of quantization points.

6. The method of claim 5, wherein the calculating of the quantization loss based on the received weight of the neural network and the weight quantized by the quantization points included in the extracted subset of quantization points comprises calculating an L2 loss or an L4 loss for a difference between the received weight of the neural network and the quantized weight as the quantization loss.

7. The method of claim 1, wherein the generating of the target subset of quantization points comprises determining a subset of quantization points that minimizes the quantization loss to be the target subset.

8. A non-transitory computer-readable storage medium storing instructions that, when executed by a processor, cause the processor to perform the neural network operation method of claim 1.

9. A neural network operation apparatus, comprising:
a memory, configured to store a weight of a neural network and a target subset of quantization points extracted from a candidate set of quantization points to quantize the weight of the neural network;
a decoder, configured to select a target quantization point from the target subset of quantization points based on the weight of the neural network;
a shifter, configured to perform a multiplication operation based on the target quantization point; and
an accumulator, configured to accumulate an output of the shifter.

10. The apparatus of claim 9, wherein the target subset is generated based on the weight of the neural network, and a quantization loss for a subset of quantization points extracted from the candidate set.

11. The apparatus of claim 9, wherein the shifter comprises:
a first shifter, configured to perform a first multiplication operation for input data based on a first quantization point included in the target quantization point; and
a second shifter, configured to perform a second multiplication operation for the input data based on a second quantization point included in the target quantization point.

12. The apparatus of claim 9, wherein the decoder comprises a multiplexer, configured to multiplex the target quantization point using the weight as a selector.

13. The apparatus of claim 9, wherein the target quantization point is shared between multiply-accumulate (MAC) operators.

14. A neural network operation apparatus, comprising:
a receiver, configured to receive a weight of a neural network, a candidate set of quantization points, and a bitwidth that represents the weight; and
one or more processors, configured to extract a subset of quantization points from the candidate set of quantization points based on the bitwidth, calculate a quantization loss based on the weight of the neural network and the subset of quantization points, and generate a target subset of quantization points based on the calculated quantization loss.

15. The apparatus of claim 14, wherein the one or more processors are further configured to generate the candidate set based on log-scale quantization.

16. The apparatus of claim 15, wherein the one or more processors are further configured to obtain a first quantization point based on the log-scale quantization, obtain a second quantization point based on the log-scale quantization, and generate the candidate set of quantization points based on a sum of the first quantization point and the second quantization point.

17. The apparatus of claim 14, wherein the one or more processors are further configured to determine a number of elements of the subset based on the bitwidth, and extract a subset corresponding to the number of elements from the candidate set of quantization points.

18. The apparatus of claim 14, wherein the one or more processors are further configured to calculate the quantization loss based on the weight of the neural network and a weight quantized by the quantization points included in the subset.

19. The apparatus of claim 18, wherein the one or more processors are further configured to calculate an L2 loss or an L4 loss for a difference between the weight of the neural network and the quantized weight as the quantization loss.

20. The apparatus of claim 14, wherein the one or more processors are further configured to determine a subset that minimizes the quantization loss to be the target subset.
